(19) United States
(12) Patent Application Publication
(10) Pub. No.: US 2021/0054668 A1
(43) Pub. Date: Feb. 25, 2021

(54) INTERMODAL CONTAINER DOOR LOCK

(71) Applicant: David Johannes MAC DONALD, Meyersdal, Alberton (ZA)

(72) Inventor: David Johannes MAC DONALD, Meyersdal, Alberton (ZA)

(21) Appl. No.: 16/965,447

(22) PCT Filed: Sep. 26, 2018
(86) PCT No.: PCT/IB2018/057442

§ 371 Date: Sep. 24, 2020

(30) Foreign Application Priority Data
Sep. 29, 2017 (ZA) 2017/06557

(51) Int. Cl. E05C 9/24; E05C 9/06; E05C 9/16; E05C 9/18; E05B 83/02; E05B 47/00

(52) U.S. Cl. CPC E05C 9/24; E05Y 2900/604; E05C 9/16; E05C 9/1808; E05C 9/1883; E05B 83/02; E05B 47/0012; E05Y 2201/10; E05Y 2201/434; E05Y 2201/47; E05Y 2201/624; E05Y 2201/638; E05Y 2201/702; E05Y 2400/614; E05Y 2400/66; E05Y 2600/45; E05C 9/06

(57) ABSTRACT

The invention relates to a heavy-duty cargo container door lock adapted for locking a door of an intermodal container, wherein the door includes an elongate lock [12] rod which terminates in a cam [14], which is dimensioned releasably to engage a cam keeper [16], such that rotation of the lock rod [12] alternately forces the cam [14] into and out of the keeper. The door lock [10] comprises a laterally displaceable sliding carriage that is displaceable between a locked position, in which it engages the cam [14] and the cam keeper [16] so as to prevent movement of the cam [14], and an unlocked position; and actuating means [22] for displacing the sliding carriage [20] between the locked and unlocked positions.

The invention relates to a heavy-duty cargo container door lock for securing doors of intermodal containers, such as those which may be used on ships, rail lines and trucks, against theft.

### BACKGROUND TO THE INVENTION

An intermodal container is a large, standardized shipping container, which is designed and built for intermodal freight transport, which means that these containers can be used across different modes of transport from ship to rail to truck without unloading and reloading their cargo. Intermodal containers are primarily used to store and transport materials and products efficiently and securely in a global containerised intermodal freight transport system. Intermodal containers exist in many types and a number of standardized sizes, but ninety percent of the global container fleet are so-called “dry freight” or “general purpose” containers, which are durable closed steel boxes, mostly of either 6 m or 12 m standard length (although lengths of containers can vary from 2.4 m to 17.1 m), and typically between 2.6 m and 2.9 m in height. These containers have different names, such as cargo or freight container, ISO container, shipping, sea or ocean container, container van or container box. For purposes of this specification, the term “intermodal container” is used to designate all of these various types of containers used across different modes of transport, as well as containers that are integrally formed with and form part of a truck body.

Intermodal containers share a number of key construction features to withstand the stresses of intermodal transport, to facilitate their handling and to allow stacking, as well as being identifiable through their individual, unique ISO reporting mark. Typical intermodal containers are rectangular, closed box models, with steel doors fitted at one end of the container within a door frame, and made of corrugated weathering steel. Each container typically includes at least two steel door leaves that are hingedly connected to rear corner posts of the container with drop forged steel hinge blades. The blades allow 270-degree opening, which allow the doors to swing back against a container side wall. A lock box, which is a steel box, typically welded to the right-hand door, overlaps a staple welded to the left-hand door. A padlock can be attached inside the lock box through the staple to protect the lock box from direct attack, hindering attempts to gain entry into the container.

Each door is fitted with two vertically extending, elongate lock rods which extend from the bottom of the doors to the top and which are used to enable opening, closing and locking of the doors. Each lock rod terminates at opposite ends thereof (i.e. top and bottom) in a cam, which is welded in place. Cam keepers, also known as knuckles, are welded to a frame of the container and are configured such that the cams releasably engage the cam keepers. The action of engaging the cams to the keepers forms an anti-racking function. A door handle rotates the lock rods to initiate a door opening process by forcing the cams out of their keepers.

Intermodal containers containing valuables can be the target of break-ins and burglary when left unattended and cargo theft results in millions of Rands of losses annually. The doors of such containers have always been the most vulnerable area for illegal entry into a cargo space. Several interlocking devices have been developed to protect the doors of trailers and/or containers against unauthorized opening. These include, for example, lock rod clamps or crossbar locks of heavy-duty steel tubing, that clamp over the lock rods and that prevent the primary doors' handle(s) from turning. They are designed so that even if someone succeeds in cutting the padlock, they cannot turn the lock rods. Container bolts protect the doors of trailers and/or containers against forcible opening and may be placed around the door handles and locked sideways with an integrated lock cylinder.

The existing prior art solutions suffer from one or a number of disadvantages. The main disadvantage is that the existing interlocking devices that protect the doors against unauthorized opening generally engage the lock rods. However, perpetrators have become so sophisticated and well-equipped that they often use power tools to cut the lock rods above and below the locking device, effectively removing a portion of the lock rods and bypassing the locking device entirely. Another disadvantage is that some locking devices require modifications to the container itself, which is not only a cost and time delay factor, but also require skilled labour.

It is an object of the current invention to provide a heavy-duty cargo container door lock that is easily assembled without requiring any modifications to the container or container doors, and that will increase theft prevention of cargo through the container doors.

### SUMMARY OF THE INVENTION

According to the invention there is provided a heavy-duty door lock adapted for locking a door of an intermodal container, wherein the door includes at least one elongate lock rod which terminates at least at one end thereof in a cam, which is dimensioned releasably to engage a complimentarily configured cam keeper that is secured to the container such that rotation of the lock rod alternately forces the cam into and out of the keeper; the door lock comprising
a laterally displaceable sliding carriage that is displaceable between a locked position, in which it engages the cam and the cam keeper so as to prevent movement of the cam, and an unlocked position in which it is disengaged from the cam and the cam keeper; and
actuating means for displacing the sliding carriage between the locked and unlocked positions.

Particularly, the door lock comprises
a first laterally displaceable sliding carriage that is displaceable between a locked position, in which it engages the lock rod, and an unlocked position in which it is disengaged from the lock rod;
a second laterally displaceable sliding carriage that is displaceable between a locked position, in which it engages the cam and the cam keeper so as to prevent movement of the cam, and an unlocked position in which it is disengaged from the cam and the cam keeper; and
actuating means for simultaneously displacing the first and second sliding carriages between the locked and unlocked positions.

More particularly, the invention provides a heavy-duty door lock adapted for locking two neighbouring doors of an intermodal container, wherein the doors are hingedly mounted to a door frame and wherein each door includes at least one elongate lock rod extending vertically from a bottom end of the doors to a top end and which lock rod terminates at opposite ends thereof in a cam, which is dimensioned releasably to engage complimentarily configured cam keepers that are secured to the door frame, the arrangement being such that rotation of the lock rods alternately forces the cams into and out of their keepers to close and open the doors; the door lock comprising
a first set of laterally displaceable sliding carriages that are displaceable between a locked position, in which they engage the lock rods, and an unlocked position in which they are disengaged from the lock rods;
a second set of laterally displaceable sliding carriages that are displaceable between a locked position, in which they engage the cams and the cam keepers so as to prevent movement of the cams, and an unlocked position in which they are disengaged from the cams and the cam keepers; and
actuating means for simultaneously displacing the first and second sets of sliding carriages between the locked and unlocked positions.

The door lock may include a housing which is configured to house the first and second sets of sliding carriages and the actuating means, the housing comprising a base plate, two opposing side walls extending from opposite sides of the base plate, and two opposing end walls extending from opposite ends of the base plate. At least one of the end walls may include rod accommodating profiles which are dimensioned to accommodate the lock rods. The door lock may releasably be secured to the container doors such that the cams and cam keepers of neighbouring lock rods, as well as a portion of the rods itself are encased within the housing. In particular, the arrangement may be such that the base plate of the housing covers the cams and the cam keepers of neighbouring lock rods, as well as a portion of the rods itself; the side walls of the housing abuts the container doors and door frame such that the cams, cam keepers and a portion of the lock rods are housed between the side walls; one end wall of the housing abuts the door frame; and an opposite end wall of the housing, which includes the rod accommodating profiles, abuts the doors.

The first set of sliding carriages are suitably dimensioned to engage the lock rods. In particular, each of the first set of sliding carriages includes a rear locking plate which slides in between the lock rod and the container door when the sliding carriages are in the locked position, thus preventing removal of the door lock from the lock rods.

The second set of sliding carriages are suitably dimensioned to engage the cams and cam keepers. In particular, each of the second set of sliding carriages includes a rear locking plate, which slides in between the cam and the cam keeper; and a front locking plate, which slides in between the cam and the base plate of the housing, thereby effectively trapping the cam between the rear and front locking plates of the second set of sliding carriages, making it impossible for the cam to rotate. The rear locking plate may be profiled to fit over the cam keeper.

The door lock may either include a remotely operable actuating means, or a mechanically operable actuating means.

In a first embodiment of the invention, the actuating means may comprise a remotely operable worm drive cylinder, which is operatively associated with a battery powered electric motor, and which includes at least one shaft which is co-axially displaceable relative to the cylinder between an extended and a retracted position. The shaft may be connected to the first and second set of sliding carriages respectively through a series of intermittent, pivotally inter-connected levers, such that displacement of the shaft between an extended and a retracted position, slidingly displaces the carriages between the locked and the unlocked positions.

In particular, the shaft may pivotally be connected at its free end to two neighbouring first actuating cams such that linear displacement of the shaft between the extended and retracted positions imparts reciprocal rotational motion on the first actuating cams. The first actuating cams may pivotally be secured to the base plate of the housing so as to secure the first actuating cams to the housing. The first actuating cams may be rotatable in opposite directions to each other, such that when one first actuating cam rotates clockwise, the other first actuating cam rotates counter-clockwise.

Each of the first set of sliding carriages may be connected to a linearly displaceable first cam follower, with each first cam follower being connected at its free end to one of the first actuating cams, such that rotation of the first actuating cams imparts linear displacement on the first cam followers. The first cam followers may be substantially horizontally displaceable in opposite directions to displace the first set of sliding carriages between the locked and unlocked positions.

The two neighbouring first actuating cams may also respectively be pivotally connected to two spring-loaded stabiliser arms. Each stabiliser arm comprises a shaft and a spring-loaded rod which is co-axially displaceable within the shaft, the arrangement being such that rotation of the first actuating cams imparts linear displacement of the rods within the shafts of the stabiliser arms.

The stabiliser arms may respectively pivotally be connected at their opposite free ends to two second actuating cams, which in turn may pivotally be secured to the base plate of the housing so as to secure the second actuating cams to the housing. The stabiliser arms may pivotally be connected to the second actuating cams such that linear displacement of the stabiliser arms imparts reciprocal rotational motion on the second actuating cams. The second actuating cams may be rotatable in opposite directions to each other, such that when one second actuating cam rotates clockwise, the other second actuating cam rotates counter-clockwise.

Each of the second set of sliding carriages may be connected to a linearly displaceable second cam follower, with each second cam follower being connected at its free end to one of the second actuating cams, such that rotation of the second actuating cams imparts linear displacement on the second cam followers. The second cam followers may be substantially horizontally displaceable in opposite directions to displace the second set of sliding carriages between the locked and unlocked positions.

Each of the first and second cam followers are spring-loaded themselves so as to accommodate spatial variations between two neighbouring lock rods and their associated respective cams and cam keepers.

In a second embodiment of the invention, the actuating means may comprise a hand-operable crank, which is operatively associated with a crank shaft which is rotationally displaceable between a locking and an unlocking position. The crank shaft may be connected to the first and second set of sliding carriages respectively through a series of intermittent, pivotally inter-connected levers, such that displacement of the crank shaft between the locking and unlocking positions, slidingly displaces the carriages between the locked and the unlocked positions.

In particular, the crank shaft may pivotally be connected at two radially opposite positions to a first and a second spring-loaded stabiliser arm. The stabiliser arms may be connected tangentially to the crank shaft in opposite directions to each other, such that rotational motion of the crank shaft imparts reciprocal linear displacement of the stabiliser arms. Particularly, each stabiliser arm comprises a shaft and a spring-loaded rod which is co-axially displaceable within the shaft, the arrangement being such that rotation of the crank shaft imparts linear displacement of the rods within the shafts of the stabiliser arms.

The first stabiliser arm may pivotally be connected to neighbouring first actuating cams such that linear displacement of the stabiliser arm imparts reciprocal rotational motion on the first actuating cams. The first actuating cams may pivotally be secured to the base plate of the housing so as to secure the first actuating cams to the housing. The first stabiliser arm may pivotally be connected to the first actuating cams such that linear displacement of the first stabiliser arm imparts reciprocal rotational motion on the first actuating cams. The first actuating cams may be rotatable in opposite directions to each other, such that when one first actuating cam rotates clockwise, the other first actuating cam rotates counter-clockwise.

Each of the first set of sliding carriages may be connected to a linearly displaceable first cam follower, with each first cam follower being connected at its free end to one of the first actuating cams, such that rotation of the first actuating cams imparts linear displacement on the first cam followers. The first cam followers may be substantially horizontally displaceable in opposite directions to displace the first set of sliding carriages between the locked and unlocked positions.

The second stabiliser arm may pivotally be connected two second neighbouring actuating cams, which in turn may pivotally be secured to the base plate of the housing so as to secure the second actuating cams to the housing. The second stabiliser arm may pivotally be connected to the second actuating cams such that linear displacement of the second stabiliser arm imparts reciprocal rotational motion on the second actuating cams. The second actuating cams may be rotatable in opposite directions to each other, such that when one second actuating cam rotates clockwise, the other second actuating cam rotates counter-clockwise.

Each of the second set of sliding carriages may be connected to a linearly displaceable second cam follower, with each second cam follower being connected at its free end to one of the second actuating cams, such that rotation of the second actuating cams imparts linear displacement on the second cam followers. The second cam followers may be substantially horizontally displaceable in opposite directions to displace the second set of sliding carriages between the locked and unlocked positions.

Each of the first and second cam followers are spring-loaded themselves so as to accommodate spatial variations between two neighbouring lock rods and their associated respective cams and cam keepers.

The door lock may include a receiver capable of receiving a selected electronic signal and coupled to the actuating means to cause the actuating means to be energized upon receiving the selected electronic signal to move the actuating means between a locking and unlocking position; and a transmitter remote from the receiver and capable of transmitting the selected electronic signal to the receiver.

The housing may include a receiving cage for accommodating the receiver and transmitter therein, as well as all relevant electronic equipment such as a microprocessor, satellite tracking and GPS equipment, and a lithium battery.

The housing also may include a solar panel, or a series of parallel-connected solar cells, connected to the baseplate of the housing and configured to charge the lithium battery.

### SPECIFIC EMBODIMENT OF THE INVENTION

Without wishing to be bound thereto, the invention will now further be described and exemplified with reference to the following non-limiting examples and drawings, in which

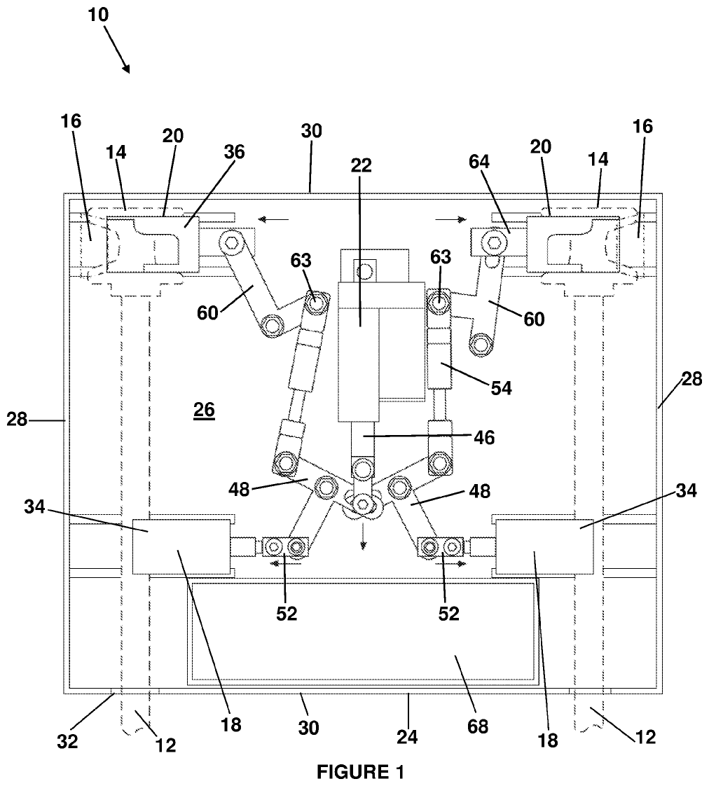

FIG. 1 is an example of a first embodiment of the door lock according to the invention in which the door lock includes remotely operable, worm drive actuating means, and which illustrates the lock in a closed position;

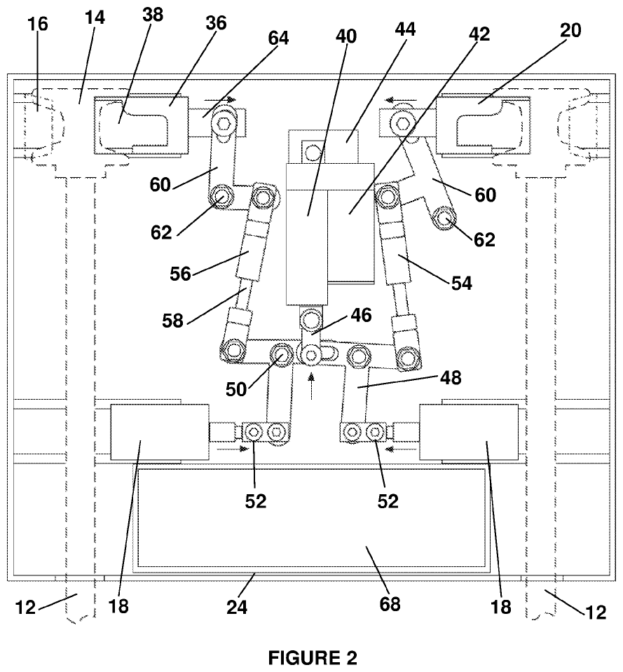

FIG. 2 is the door lock of FIG. 1, in which the lock is in an open position;

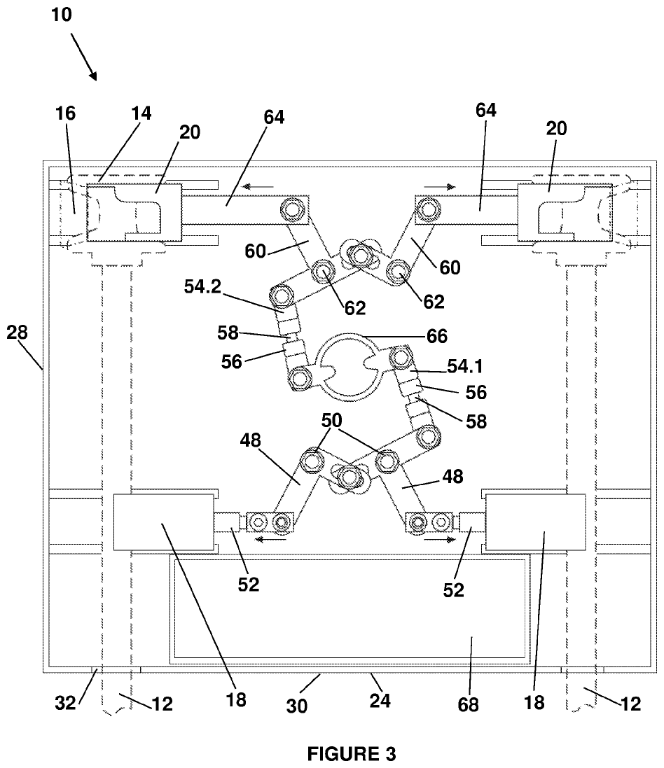

FIG. 3 is an example of a second embodiment of the door lock according to the invention in which the door lock includes mechanically operable actuating means, and which illustrates the lock in a closed position; and

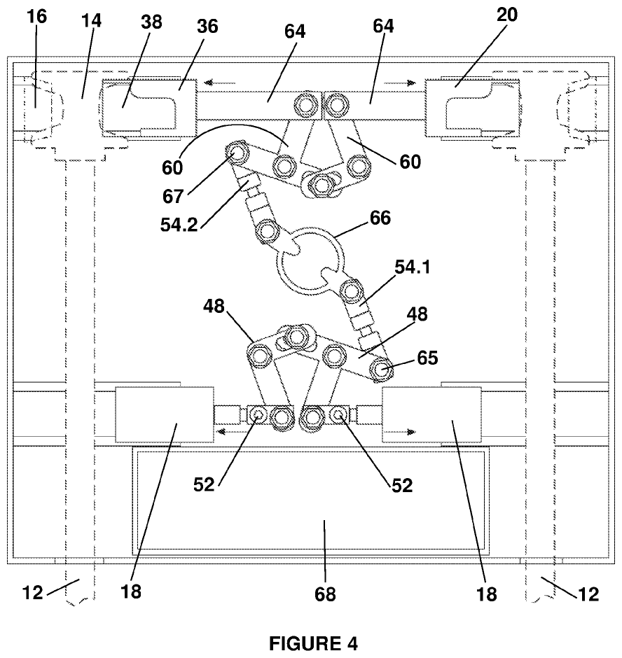

FIG. 4 is the door lock of FIG. 3, in which the lock is a closed position.

The invention provides a heavy-duty door lock [10] adapted for locking two neighbouring doors (not shown) of an intermodal container (not shown), wherein the doors are hingedly mounted to a door frame and wherein each door includes at least one elongate lock rod [12] extending vertically from a bottom end of the doors to a top end. Each lock rod [12] terminates at opposite ends thereof in a cam [14], which is dimensioned releasably to engage complimentarily configured cam keepers [16] that are secured to the door frame, the arrangement being such that rotation of the lock rods [12] alternately forces the cams [14] into and out of their keepers [16] to close and open the doors.

The door lock [10] comprises a first set of laterally displaceable sliding carriages [18] that are displaceable between a locked position, in which they engage the lock rods [12], and an unlocked position in which they are disengaged from the lock rods [12]; a second set of laterally displaceable sliding carriages [20] that are displaceable between a locked position, in which they engage the cams [14] and the cam keepers [16] so as to prevent movement of the cams [14], and an unlocked position in which they are disengaged from the cams [14] and the cam keepers [16]; and actuating means [22] for simultaneously displacing the first and second sets of sliding carriages [18; 20] between the locked and unlocked positions.

The door lock [10] includes a housing [24] which is configured to house the first and second sets of sliding carriages [18; 20] and the actuating means [22]. The housing [24] comprises a base plate [26], two opposing side walls [28] extending from opposite sides of the base plate [26], and two opposing end walls [30] extending from opposite ends of the base plate [26]. At least one of the end walls [30] includes rod accommodating profiles [32] which are dimensioned to accommodate the lock rods [12]. The door lock [10] is releasably secured to the container doors such that the cams [14] and cam keepers [16] of neighbouring lock rods [12], as well as a portion of the rods [12] itself are encased within the housing [24]. In particular, the base plate [26] of the housing [24] covers the cams [14] and the cam keepers [16] of neighbouring lock rods [12], as well as a portion of the rods [12] itself; the side walls [28] of the housing [24] abuts the container doors and door frame such that the cams [14], cam keepers [16] and a portion of the lock rods [12] are housed between the side walls [28]; one end wall [30] of the housing [24] abuts the door frame; and an opposite end wall [30] of the housing [24], which includes the rod accommodating profiles [32], abuts the doors.

The first set of sliding carriages [18] are suitably dimensioned to engage the lock rods [12]. More particularly, each of the first set of sliding carriages [18] includes a rear locking plate [34] which slides in between the lock rod [12] and the container door when the sliding carriages [18] are in the locked position, thus preventing removal of the door lock [10] from the lock rods [12].

The second set of sliding carriages [20] are suitably dimensioned to engage the cams [14] and cam keepers [16]. In particular, each of the second set of sliding carriages [20] includes a rear locking plate [36], which slides in between the cam [14] and the cam keeper [16]; and a front locking plate [38], which slides in between the cam [14] and the base plate [26] of the housing [24], thereby effectively trapping the cam [14] between the rear and front locking plates [36, 38] of the second set of sliding carriages [20], making it impossible for the cam [14] to rotate. The rear locking plate [36] is profiled to fit over the cam keeper [16].

The door lock [10] either includes a remotely operable actuating means [22], as illustrated in FIGS. 1 and 2; or a mechanically operable actuating means [22], as illustrated in FIGS. 3 and 4.

In a first embodiment of the invention, the actuating means [22] comprise a remotely operable worm drive cylinder [40], which is operatively associated with a battery powered electric motor [42] and gearbox [44], and which includes at least one shaft [46] which is co-axially displaceable relative to the cylinder [40] between an extended position (refer FIG. 1) and a retracted position (refer FIG. 2). The shaft [46] is connected to the first and second set of sliding carriages [18, 20] respectively through a series of intermittent, pivotally inter-connected levers, such that displacement of the shaft [46] between the extended and retracted positions, slidingly displaces the carriages [18, 20] between the locked and the unlocked positions.

In particular, the shaft [46] is pivotally connected at its free end to two neighbouring first actuating cams [48] such that linear displacement of the shaft [46] between the extended and retracted positions imparts reciprocal rotational motion on the first actuating cams [48]. The first actuating cams [48] are pivotally secured to the base plate [26] of the housing [24] at [50] so as to secure the first actuating cams [48] to the housing [24]. The first actuating cams [48] are rotatable in opposite directions to each other, such that when one first actuating cam rotates clockwise, the other first actuating cam rotates counter-clockwise.

Each one of the first set of sliding carriages [18] is connected to a linearly displaceable first cam follower [52], with each first cam follower [52] being connected at its free end to one of the first actuating cams [48], such that rotation of the first actuating cams [48] imparts linear displacement on the first cam followers [52]. The first cam followers [52] are substantially horizontally displaceable in opposite directions to displace the first set of sliding carriages [18] between the locked and unlocked positions.

The two neighbouring first actuating cams [48] are also respectively pivotally connected to two spring-loaded stabiliser arms [54]. Each stabiliser arm [54] comprises a shaft [56] and a spring-loaded rod [58] which is co-axially displaceable within the shaft [56], the arrangement being such that rotation of the first actuating cams [48] imparts linear displacement of the rods [58] within the shafts [56] of the stabiliser arms [54].

The stabiliser arms [54] are respectively pivotally connected at their opposite free ends to two second actuating cams [60], which in turn are pivotally secured at [62] to the base plate [26] of the housing [24] so as to secure the second actuating cams [60] to the housing [24]. The stabiliser arms [54] are pivotally connected at [63] to the second actuating cams [60] such that linear displacement of the stabiliser arms [54] imparts reciprocal rotational motion on the second actuating cams [60]. The second actuating cams [60] are rotatable in opposite directions to each other, such that when one second actuating cam rotates clockwise, the other second actuating cam rotates counter-clockwise.

Each one of the second set of sliding carriages [20] is connected to a linearly displaceable second cam follower [64], with each second cam follower [64] being connected at its free end to one of the second actuating cams [60], such that rotation of the second actuating cams [60] imparts linear displacement on the second cam followers [64]. The second cam followers [64] are substantially horizontally displaceable in opposite directions to displace the second set of sliding carriages [20] between the locked and unlocked positions.

Each of the first and second cam followers [52, 64] are spring-loaded themselves so as to accommodate spatial variations between two neighbouring lock rods [12] and their associated respective cams [14] and cam keepers [16].

In a second embodiment of the invention, the actuating means [22] comprise a hand-operable crank (not shown), which is operatively associated with a crank shaft [66] which is rotationally displaceable between a locking and an unlocking position. The crank shaft [66] is connected to the first and second set of sliding carriages [18, 20] respectively through a series of intermittent, pivotally inter-connected levers, such that displacement of the crank shaft [66] between the locking and unlocking positions, slidingly displaces the carriages [18, 20] between the locked and the unlocked positions.

In particular, the crank shaft [66] is pivotally connected at two radially opposite positions to a first and a second spring-loaded stabiliser arm [54]. The stabiliser arms [54] are connected tangentially to the crank shaft [66] in opposite directions to each other, such that rotational motion of the crank shaft [66] imparts reciprocal linear displacement of the stabiliser arms [54]. Particularly, each stabiliser arm [54] comprises a shaft [56] and a spring-loaded rod [58] which is co-axially displaceable within the shaft [56], the arrangement being such that rotation of the crank shaft [66] imparts linear displacement of the rods [58] within the shafts [56] of the stabiliser arms [54].

The first stabiliser arm [54.1] is pivotally connected to two neighbouring first actuating cams [48] such that linear displacement of the stabiliser arm [54] imparts reciprocal rotational motion on the first actuating cams [48]. The first actuating cams [48] are pivotally secured to the base plate [26] of the housing [24] at [50] so as to secure the first actuating cams [48] to the housing [24]. The first stabiliser arm [54.1] is pivotally connected to the first actuating cams [48] at [65] such that linear displacement of the first stabiliser arm [54.1] imparts reciprocal rotational motion on the first actuating cams [48]. The first actuating cams [48] are rotatable in opposite directions to each other, such that when one first actuating cam rotates clockwise, the other first actuating cam rotates counter-clockwise.

Each one of the first set of sliding carriages [18] is connected to a linearly displaceable first cam follower [52], with each first cam follower [52] being connected at its free end to one of the first actuating cams [48], such that rotation of the first actuating cams [48] imparts linear displacement on the first cam followers [52]. The first cam followers [52] are substantially horizontally displaceable in opposite directions to displace the first set of sliding carriages [18] between the locked and unlocked positions.

The second stabiliser arm [54.2] is pivotally connected at [67] to two second neighbouring actuating cams [60], which in turn is pivotally secured at [62] to the base plate [26] of the housing [24] so as to secure the second actuating cams [60] to the housing [24]. The second stabiliser arm [54.2] is pivotally connected to the second actuating cams [60] such that linear displacement of the second stabiliser arm [54.2] imparts reciprocal rotational motion on the second actuating cams [60]. The second actuating cams [60] are rotatable in opposite directions to each other, such that when one second actuating cam rotates clockwise, the other second actuating cam rotates counter-clockwise.

Each one of the second set of sliding carriages [20] is connected to a linearly displaceable second cam follower [64], with each second cam follower [64] being pivotally connected at its free end to one of the second actuating cams [60], such that rotation of the second actuating cams [60] imparts linear displacement on the second cam followers [64]. The second cam followers [64] are substantially horizontally displaceable in opposite directions to displace the second set of sliding carriages [20] between the locked and unlocked positions.

Each of the first and second cam followers [52, 64] are spring-loaded themselves so as to accommodate spatial variations between two neighbouring lock rods [12] and their associated respective cams [14] and cam keepers [16].

The door lock [10] includes a receiver (not shown) capable of receiving a selected electronic signal and coupled to the actuating means [22] to cause the actuating means [22] to be energized upon receiving the selected electronic signal to move the actuating means [22] between a locking and unlocking position; and a transmitter (not shown) remote from the receiver and capable of transmitting the selected electronic signal to the receiver.

The housing [24] includes a receiving cage [68] for accommodating the receiver and transmitter therein, as well as all relevant electronic equipment such as a microprocessor, satellite tracking and GPS equipment, and a lithium battery.

The housing [24] also includes a solar panel, or a series of parallel-connected solar cells (not shown), connected to the baseplate of the housing [24] and configured to charge the lithium battery.

It will be appreciated that alternative embodiments of the invention may be possible without departing from the spirit or scope of the invention as set out in the claims.

1. A heavy-duty door lock adapted for locking a door of an intermodal container, wherein the door includes at least one elongate lock rod which terminates at least at one end thereof in a cam, which is dimensioned releasably to engage a complimentarily configured cam keeper that is secured to the container such that rotation of the lock rod alternately forces the cam into and out of the keeper; the door lock comprising
a laterally displaceable sliding carriage that is displaceable between a locked position, in which it engages the cam and the cam keeper so as to prevent movement of the cam, and an unlocked position in which it is disengaged from the cam and the cam keeper; and
actuating means for displacing the sliding carriage between the locked and unlocked positions.

2. The door lock according to claim 1 wherein the door lock comprises
a first laterally displaceable sliding carriage that is displaceable between a locked position, in which it engages the lock rod, and an unlocked position in which it is disengaged from the lock rod;
a second laterally displaceable sliding carriage that is displaceable between a locked position, in which it engages the cam and the cam keeper so as to prevent movement of the cam, and an unlocked position in which it is disengaged from the cam and the cam keeper; and
actuating means for simultaneously displacing the first and second sliding carriages between the locked and unlocked positions.

3. The door lock according to claim 2 wherein the door lock is adapted for locking two neighbouring doors of an intermodal container, wherein the doors are hingedly mounted to a door frame and wherein each door includes at least one elongate lock rod extending vertically from a bottom end of the doors to a top end and which lock rod terminates at opposite ends thereof in a cam, which is dimensioned releasably to engage complimentarily configured cam keepers that are secured to the door frame, the arrangement being such that rotation of the lock rods alternately forces the cams into and out of their keepers to close and open the doors; the door lock comprising
a first set of laterally displaceable sliding carriages that are displaceable between a locked position, in which they engage the lock rods, and an unlocked position in which they are disengaged from the lock rods;
a second set of laterally displaceable sliding carriages that are displaceable between a locked position, in which they engage the cams and the cam keepers so as to prevent movement of the cams, and an unlocked position in which they are disengaged from the cams and the cam keepers; and
actuating means for simultaneously displacing the first and second sets of sliding carriages between the locked and unlocked positions.

4. The door lock according to claim 3 wherein the door lock includes a housing which is configured to house the first and second sets of sliding carriages and the actuating means, the housing comprising a base plate, two opposing side walls extending from opposite sides of the base plate, and two opposing end walls extending from opposite ends of the base plate, with at least one of the end walls including rod accommodating profiles which are dimensioned to accommodate the lock rods, the arrangement being such that the door lock is releasably secured to the container doors in such a way that the cams and cam keepers of neighbouring lock rods, as well as a portion of the rods itself, are encased within the housing.

5. The door lock according to claim 4 wherein the base plate of the housing covers the cams and the cam keepers of neighbouring lock rods, as well as a portion of the rods itself; the side walls of the housing abut the container doors and door frame such that the cams, cam keepers and a portion of the lock rods are housed between the side walls; one end wall of the housing abuts the door frame; and an opposite end wall of the housing which includes the rod accommodating profiles, abuts the doors.

6. The door lock according to claim 3 wherein the first set of sliding carriages are suitably dimensioned to engage the lock rods and wherein each of the first set of sliding carriages includes a rear locking plate which slides in between the lock rod and the container door when the sliding carriages are in the locked position, thus preventing unauthorised removal of the door lock from the lock rods.

7. The door lock according to claim 4 wherein the second set of sliding carriages are suitably dimensioned to engage the cams and cam keepers and wherein each of the second set of sliding carriages includes a rear locking plate, which is profiled to fit over the cam keeper and which slides in between the cam and the cam keeper; and a front locking plate, which slides in between the cam and the base plate of the housing, thereby effectively trapping the cam between the rear and front locking plates of the second set of sliding carriage, making it impossible for the cam to rotate.

8. The door lock according to claim 3 wherein the door lock either includes a remotely operable actuating means, or a mechanically operable actuating means.

9. The door lock according to claim 8 wherein in a first embodiment of the invention, the actuating means comprise a remotely operable worm drive cylinder, which is operatively associated with a battery powered electric motor, and which includes at least one shaft which is co-axially displaceable relative to the cylinder between an extended and a retracted position.

10. The door lock according to claim 9 wherein the shaft is connected to the first and second set of sliding carriages respectively through a series of intermittent, pivotally inter-connected levers, such that displacement of the shaft between an extended and a retracted position, slidingly displaces the carriages between the locked and the unlocked positions.

11. The door lock according to claim 10 wherein the shaft is pivotally connected at its free end to two neighbouring first actuating cams such that linear displacement of the shaft between the extended and retracted positions imparts reciprocal rotational motion on the first actuating cams.

12. The door lock according to claim 4 wherein the first actuating cams are pivotally secured to the base plate of the housing so as to secure the first actuating cams to the housing and wherein the first actuating cams are rotatable in opposite directions to each other, such that when one first actuating cam rotates clockwise, the other first actuating cam rotates counter-clockwise.

13. The door lock according to claim 11 wherein each of the first set of sliding carriages is connected to a linearly displaceable first cam follower, with each first cam follower being connected at its free end to one of the first actuating cams, such that rotation of the first actuating cams imparts linear displacement on the first cam followers, the arrangement being such that the first cam followers are substantially horizontally displaceable in opposite directions to displace the first set of sliding carriages between the locked and unlocked positions.

14. The door lock according to claim 13 wherein the two neighbouring first actuating cams are also respectively pivotally connected to two spring loaded stabiliser arms wherein each stabiliser arm comprises a shaft and a spring-loaded rod which is co-axially displaceable within the shaft the arrangement being such that rotation of the first actuating cams imparts linear displacement of the rods within the shafts of the stabiliser arms.

15. The door lock according to claim 14 wherein the stabiliser arms are respectively pivotally connected at their opposite free ends to two second actuating cams, which in turn are pivotally secured to the base plate of the housing so as to secure the second actuating cams to the housing the arrangement being such that the stabiliser arms are pivotally connected to the second actuating cams such that linear displacement of the stabiliser arms imparts reciprocal rotational motion on the second actuating cams.

16. The door lock according to claim 15 wherein the second actuating cams are rotatable in opposite directions to each other, such that when one second actuating cam rotates clockwise, the other second actuating cam rotates counter-clockwise.

17. The door lock according to claim 16 wherein each of the second set of sliding carriages are connected to a linearly displaceable second cam follower with each second cam follower being connected at its free end to one of the second actuating cams, such that rotation of the second actuating cams imparts linear displacement on the second cam followers, the arrangement being such that the second cam followers are substantially horizontally displaceable in opposite directions to displace the second set of sliding carriages between the locked and unlocked positions.

18. The door lock according to claim 17 wherein each of the first and second cam followers are spring-loaded themselves so as to accommodate spatial variations between two neighbouring lock rods and their associated respective cams and cam keepers.

19. The door lock according to claim 8 wherein in a second embodiment of the invention, the actuating means comprise a hand-operable crank, which is operatively associated with a crank shaft which is rotationally displaceable between a locking and an unlocking position.

20. The door lock according to claim 19 wherein the crank shaft [66] is connected to the first and second set of sliding carriages respectively through a series of intermittent, pivotally inter-connected levers, such that displacement of the crank shaft between the locking and unlocking positions, slidingly displaces the carriages between the locked and the unlocked positions.

21. The door lock according to claim 20 wherein the crank shaft is pivotally connected at two radially opposite positions to a first and a second spring-loaded stabiliser arm, the stabiliser arms being connected tangentially to the crank shaft in opposite directions to each other, such that rotational motion of the crank shaft imparts reciprocal linear displacement of the stabiliser arms; wherein each stabiliser arm comprises a shaft and a spring-loaded rod which is co-axially displaceable within the shaft the arrangement being such that rotation of the crank shaft imparts linear displacement of the rods within the shafts of the stabiliser arms.

22. The door lock according to claim 21 wherein the first stabiliser arm is pivotally connected to neighbouring first actuating cams such that linear displacement of the stabiliser arm imparts reciprocal rotational motion on the first actuating cams.

23. The door lock according to claim 22 wherein the first actuating cams are pivotally secured to the base plate of the housing and wherein the first stabiliser arm is pivotally connected to the first actuating cams such that linear displacement of the first stabiliser arm imparts reciprocal rotational motion on the first actuating cams, the arrangement being such that the first actuating cams are rotatable in opposite directions to each other, such that when one first actuating cam rotates clockwise, the other first actuating cam rotates counter-clockwise.

24. The door lock according to claim 23 wherein each of the first set of sliding carriages are connected to a linearly displaceable first cam follower, with each first cam follower being connected at its free end to one of the first actuating cams, such that rotation of the first actuating cams imparts linear displacement on the first cam followers, the arrangement being such that the first cam followers are substantially horizontally displaceable in opposite directions to displace the first set of sliding carriages between the locked and unlocked positions.

25. The door lock according to claim 24 wherein the second stabiliser arm is pivotally connected to two second neighbouring actuating cams, which in turn are pivotally secured to the base plate of the housing the second stabiliser arm being pivotally connected to the second actuating cams such that linear displacement of the second stabiliser arm imparts reciprocal rotational motion on the second actuating cams, the arrangement being such that the second actuating cams are rotatable in opposite directions to each other, such that when one second actuating cam rotates clockwise, the other second actuating cam rotates counter-clockwise.

26. The door lock according to claim 25 wherein each of the second set of sliding carriages are connected to a linearly displaceable second cam follower, with each second cam follower being connected at its free end to one of the second actuating cams, such that rotation of the second actuating cams imparts linear displacement on the second cam followers, the arrangement being such that the second cam followers are substantially horizontally displaceable in opposite directions to displace the second set of sliding carriages between the locked and unlocked positions.

27. The door lock according to claim 26 wherein each of the first and second cam followers are spring-loaded themselves so as to accommodate spatial variations between two neighbouring lock rods and their associated respective cams and cam keepers.

28. The door lock according to claim 1 wherein door lock includes a receiver capable of receiving a selected electronic signal and coupled to the actuating means to cause the actuating means to be energized upon receiving the selected electronic signal to move the actuating means between a locking and unlocking position; and a transmitter remote from the receiver and capable of transmitting the selected electronic signal to the receiver.

29. The door lock according to claim 28 wherein the housing includes a receiving cage for accommodating the receiver and transmitter therein, as well as all relevant electronic equipment such as a microprocessor, satellite tracking and GPS equipment, and a lithium battery.

30. The door lock according to claim 29 wherein the housing also includes a solar panel, or a series of parallel-connected solar cells, connected to the baseplate of the housing and configured to charge the lithium battery.

31. The heavy-duty door lock according to claim 1 substantially as herein illustrated and exemplified with reference to the accompanying drawings.
